(19) United States
(12) Patent Application Publication
(10) Pub. No.: US 2026/0219767 A1
(43) Pub. Date: Jul. 30, 2026

(54) INFORMATION PROCESSING SYSTEM, APPLICATION CREATION SYSTEM, TERMINAL APPARATUS, AND APPLICATION CREATION METHOD

(71) Applicants: Sakiko TOMIZAWA, Tokyo (JP); Atsuya OSAWA, Kanagawa (JP); Yuki HORI, Aichi (JP); Seiichi KONDO, Tokyo (JP)

(72) Inventors: Sakiko TOMIZAWA, Tokyo (JP); Atsuya OSAWA, Kanagawa (JP); Yuki HORI, Aichi (JP); Seiichi KONDO, Tokyo (JP)

(21) Appl. No.: 19/452,924

(22) Filed: Jan. 20, 2026

(30) Foreign Application Priority Data
Jan. 27, 2025 (JP) 2025-011296
Oct. 30, 2025 (JP) 2025-183464

(51) Int. Cl. G06F 3/0484; G06F 3/0482; G06F 9/451; G06F 40/143

(52) U.S. Cl. CPC G06F 3/0484; G06F 3/0482; G06F 9/453; G06F 40/143

(57) ABSTRACT

An information processing system includes circuitry to: display a screen for assisting creation of an application, including a first option including a plurality of options of an application type of the application; in response to reception of a selected application type selected from the first option, display on the screen a second option including a plurality of options of an item to be managed by the application having the selected application type; in response to reception of one or more selected items selected from the second option, generate an instruction including first information identifying the selected application type, second information identifying the one or more selected items, and setting data for creating the application; transmit the instruction to the generative AI system; receive a request generated by the generative AI system, the request including the setting data; and create the application based on the setting data.

### CROSS-REFERENCE TO RELATED APPLICATIONS

This patent application is based on and claims priority pursuant to 35 U.S.C. § 119(a) to Japanese Patent Application Nos. 2025-011296, filed on Jan. 27, 2025, and 2025-183464, filed on Oct. 30, 2025, in the Japan Patent Office, the entire disclosure of which is hereby incorporated by reference herein.

### BACKGROUND

### Technical Field

The present disclosure relates to an information processing apparatus, an application creation system, a terminal apparatus, and an application creation method.

### Related Art

There is a technique that assists programming by eliminating or reducing the need to manually enter program code. For example, artificial intelligence (AI) can be used to automatically generate program code.

### SUMMARY

The present disclosure described herein provides an information processing system communicably connected with a terminal apparatus and a generative artificial intelligence (AI) system via a network, the information processing system comprising circuitry to: display, on a display, a screen for assisting creation of an application, the screen including a first option including a plurality of options of an application type of the application to be created; in response to reception of a selected application type selected from the first option, display on the screen a second option including a plurality of options of an item to be managed by the application having the selected application type; in response to reception of one or more selected items selected from the second option, generate an instruction including first information identifying the selected application type, second information identifying the one or more selected items, and setting data for creating the application; transmit the instruction to the generative AI system; receive a request generated by the generative AI system based on the instruction, the request including the setting data for creating the application; and create the application based on the setting data included in the request.

The present disclosure described herein provides an application creation system including the information processing system and the terminal apparatus including the display to display the screen.

The present disclosure described herein provides a terminal apparatus communicably connected with an information processing system and a generative artificial intelligence (AI) system via a network, the terminal apparatus including circuitry to: display, on a display, a screen for assisting creation of an application, the screen including a first option including a plurality of options of an application type of the application to be created; in response to reception of a selected application type selected from the first option, display on the screen a second option including a plurality of options of an item to be managed by the application having the selected application type; in response to reception of one or more selected items selected from the second option, generate an instruction including first information identifying the selected application type, second information identifying the one or more selected items, and setting data for creating the application; transmit the instruction to the generative AI system; receive a first request generated by the generative AI system based on the instruction, the first request including the setting data for creating the application; transmit a second request including the setting data included in the first request to the information processing system, the second request causing the information processing system to create the application based on the setting data included in the second request.

The present disclosure described herein provides an application creation system including the terminal apparatus and the information processing system including another circuitry to create the application in response to the second request received from the terminal apparatus.

The present disclosure described herein provides an application creation method comprising: displaying, on a display, a screen for assisting creation of an application, the screen including a first option including a plurality of options of an application type of the application to be created; in response to reception of a selected application type selected from the first option, displaying on the screen a second option including a plurality of options of an item to be managed by the application having the selected application type; in response to reception of one or more selected items selected from the second option, generating an instruction including first information identifying the selected application type, second information identifying the one or more selected items, and setting data for creating the application; transmitting the instruction to a generative artificial intelligence (AI) system; and receiving a request generated by the generative AI system based on the instruction, the request including the setting data for creating the application, the setting data including a function name identifying a function that causes creation of the application.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an example of a configuration of an application creation system according to a first embodiment;

FIG. 2 is a diagram illustrating an overview of an operation performed by the application creation system according to the first embodiment;

FIG. 3 is a diagram illustrating an example of a hardware configuration of an information processing system, a user terminal, and a developer terminal;

FIG. 4 is a diagram illustrating functions of each apparatus included in the application creation system according to the first embodiment;

FIG. 5 is an example of an application type table;

FIGS. 6A and 6B are examples of a management item table;

FIG. 7 is an example of an application management table;

FIG. 8 is a sequence diagram illustrating an operation performed by the application creation system according to the first embodiment;

FIG. 9 is a diagram illustrating a first example of a screen displayed on the user terminal according to the first embodiment;

FIG. 10 is a diagram illustrating a second example of a screen displayed on the user terminal according to the first embodiment;

FIG. 11 is a diagram illustrating an example prompt;

FIG. 12 is a diagram illustrating an example of a response message transmitted from the generative AI system in response to the prompt;

FIG. 13 is a diagram illustrating a third example of a screen displayed on the user terminal according to the first embodiment;

FIG. 14 is a diagram illustrating a fourth example of a screen displayed on the user terminal according to the first embodiment;

FIG. 15 is a diagram illustrating a first example of a screen displayed on the user terminal according to a second embodiment;

FIG. 16 is a diagram illustrating a second example of a screen displayed on the user terminal according to the second embodiment;

FIG. 17 is a diagram illustrating a third example of a screen displayed on the user terminal according to the second embodiment;

FIG. 18 is a sequence diagram illustrating an operation performed by the application creation system according to the third embodiment;

FIG. 19 is a diagram illustrating functions performed by each apparatus included in the application creation system according to the third embodiment; and

FIG. 20 is a sequence diagram illustrating an operation performed by the application creation system according to the third embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

### First Embodiment

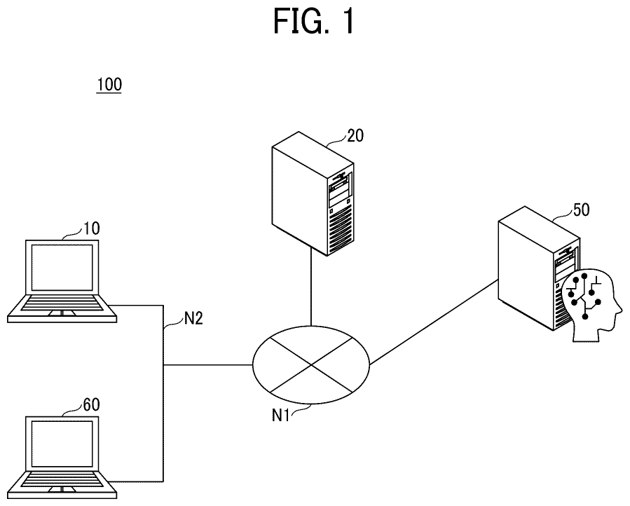

FIG. 1 is a diagram illustrating a configuration of an application creation system 100 according to a first embodiment.

The application creation system 100 includes an information processing system (server) 20, a user terminal 10, and a developer terminal 60.

In the application creation system 100, the information processing system 20 and the user terminal 10, and the information processing system 20 and the developer terminal 60, are communicably connected to each other via networks N1 and N2. The information processing system 20 communicates with a generative AI system 50 via the network N1. The user terminal 10 and the developer terminal 60 are communicatively connected to the generative AI system 50 via the networks N1 and N2.

The network N1 is a network for a wide area, such as Internet or a wide area network (WAN). The network N2 may be a local area network (LAN), Wi-Fi®, a wide area Ethernet®, or a mobile phone network of 4G, 5G, or 6G.

The user terminal 10 is, for example, a terminal apparatus used by a user who uses a service provided by the information processing system 20, such as a personal computer (PC), a smartphone, or a tablet terminal. The developer terminal 60 is a terminal apparatus used by, for example, a developer of the information processing system 20.

The user terminal 10 and the developer terminal 60, which are provided at facilities such as companies or homes, are connected to the network N2. The user terminal 10 and the developer terminal 60 are not necessarily connected to the network N2 all the time, and may be connected to the network N2 when using the information processing system 20 or the generative AI system 50. A web browser or a native application operates on the user terminal 10 or the developer terminal 60. The user terminal 10 or the developer terminal 60 can use various services provided by the information processing system 20 or the generative AI system 50.

When the user inputs information on an application, the user terminal 10 transmits the input content to the information processing system 20. The information on the application includes a type of the application, and one or more fields to be managed in the application, which may be referred to as the management items.

The application created in the present embodiment is, for example, a database web application that manages data in the form of a table. The user can freely set the management items of the application, so that the application can be customized to store, read, or process data related to the work of the user. In the description below, the term “application” may be referred to as an “app”.

The developer terminal 60 generates setting data used to create an application in response to an operation by the developer. The setting data is stored in the information processing system 20. Details of the setting data will be described later.

The generative AI system 50 provides a service for the user to chat with the AI. The generative AI system 50 may be based on the large language model (LLM). The large language model is a model designed for the natural language processing, which is trained using a large amount of text data.

The generative AI system 50 is input with a vast amount of text, and obtains knowledge from the input text, for example, by deep learning or reinforcement learning. The generative AI system 50 uses the obtained knowledge to output a response message to data based on the chat message.

The generative AI system 50 includes an interface that receives data input by the user, such as a chat message or an electronic file. The data such as the chat message or the file received by this interface is referred to as a prompt. As the prompt, a chat message of an instruction or question is input. The chat message may be a part of the conversation or words in the natural language spoken by the human. One example of the electronic file is an image. The generative AI system 50 that generates a sentence with respect to the chat message may be referred to as the generative AI.

Example features of the generative AI system 50 include the capabilities to carry on a chat in a natural flow, expand ideas and make suggestions in a field in which the user lacks knowledge, and output accurate program code.

The generative AI system 50 may be based on LLM such as GPT-3®, GPT-4®,Transformer®, or BERT®. It is assumed that the application creation system 100 uses the ChatGPT based on GPT-3 or GPT-4 as an example. Alternatively the application creation system 100 may use any other LLM.

The generative AI system 50 and the information processing system 20 may be provided by the same provider or different providers.

When the information processing system 20 receives an operation to start creation of an application from the user terminal 10, the information processing system 20 causes the user terminal 10 to display an assistant screen to assist the user in creating application. The assistant screen includes, for example, options of the application type and options of management item to be managed in the application.

The information processing system 20 transmits an instruction to create the application, which includes the input content input on the assistant screen displayed on the user terminal 10, to the generative AI system 50. In response to receiving a request including a parameter related to creation of the application from the generative AI system 50, the information processing system 20 creates an application based on the received parameter and provides the application to the user terminal 10.

In this manner, the user can create the application by selecting the application type or the management items to be managed in the application via the assistance screen displayed on the user terminal 10. With this configuration, even the user who does not have knowledge about the program code can easily create the application.

In the example of FIG. 1, the generative AI system 50 and the information processing system 20 are separately provided, but the present disclosure is not limited to this configuration. For example, the generative AI system 50 and the information processing system 20 may be combined into one system.

The information processing system 20 may be implemented by cloud computing or may be implemented by a single information processing apparatus. The “cloud computing” refers to internet-based computing where resources on a network are used or accessed without identifying specific hardware resources. The information processing system 20 may be present on the Internet or on the premises.

The functions of the information processing system (server) 20 may be distributed over a plurality of information processing apparatuses. A plurality of information processing apparatuses having the same functions may be provided, and the number of information processing apparatuses that execute processes may be changed in accordance with the processing load. For simplicity, the information processing system 20 may also be referred to as an information processing server or a server.

The user terminal 10 is, for example, a terminal apparatus used by a user who receives a service provided by the information processing system 20, such as a PC, a smartphone, or a tablet terminal.

The user terminal 10 or the developer terminal 60 may be implemented by an information processing apparatus. Examples of the information processing apparatuses include an output apparatus such as an electronic whiteboard or a digital signage, head-up display (HUD), an industrial machine, an imaging apparatus such as a digital camera, a sound collecting apparatus, medical device, network home appliance, a mobile phone, a smartphone, a tablet terminal, a game machine, a personal digital assistant (PDA), and a wearable PC.

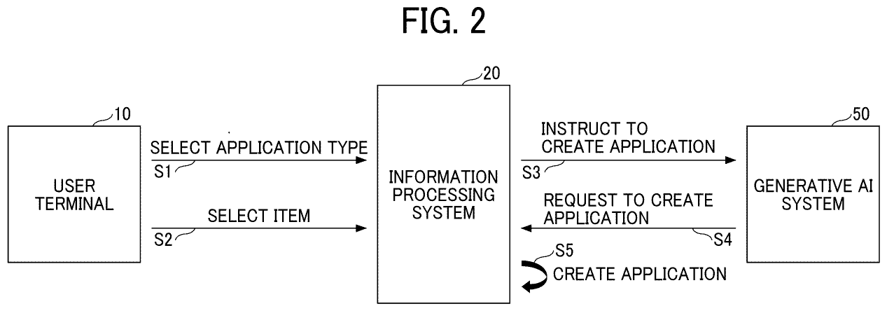

An example operation performed by the application creation system 100 is described below with reference to FIG. 2. FIG. 2 is a schematic diagram illustrating an example operation performed by the application creation system 100 according to the first embodiment.

In the application creation system 100, at step S1, the user terminal 10 transmits information indicating the type of the application selected on the assistant screen to the information processing system 20. In the following description, the information indicating the type of the application may be referred to as an application type. At step S2, the user terminal 10 transmits the management items selected on the assistant screen to the information processing system 20.

When the information processing system 20 receives the application type and the management items selected by the user, at step S3, the information processing system 20 transmits an instruction to create an application having the selected application type and including the selected management items to the generative AI system 50. The information processing system 20 transmits a prompt to the generative AI system 50 via an application programming interface (API) for receiving the prompt, which is provided by the generative AI system 50. The prompt is an example of an instruction to create an application. The information processing system 20 transmits the prompt including the specification of a function.

The function is a program interface that performs a preset process with a specified argument and returns a return value as a result. Specifically, the function is a function for enabling the generative AI system 50 to request the information processing system 20 to create an application, based on parameters indicating the application type and the management items that are selected by the user. The information processing system 20 transmits, to the generative AI system 50, a prompt that includes the setting of the specification of the function.

The above-described request to the information processing system 20, which is made by the generative AI system 50 to call the function, is referred to as the function call. The information processing system 20 generates the prompt that includes the information related to the application.

The information related to the application is information indicating parameters managed by the application. The parameters managed by the application include, for example, a field name (management item name) managed by the application, and the number of fields (the number of management items).

The information processing system 20 may not cause the prompt to include the information related to the application and the setting of the specification of the function. For example, the information processing system 20 may generate a prompt including the input content input at the user terminal 10 and an instruction related to creation of an application based on the input content, and transmits the prompt to the generative AI system 50.

The information processing system 20 may transmit the information related to the application and the settings of the specification of the function to the generative AI system 50, separately, in different prompts.

At step S4, the generative AI system 50 transmits a request for creating an application to the information process system 20 based on the information related to the application and the setting data of the specification of the function, which are included in the prompt. At this time, the generative AI system 50 transmits a response (application creation request) including a function call request (function call) to the information processing system 20.

The generative AI system 50 only requests the information processing system 20 to call a function.

At step S5, the information process system 20 receives the response from the generative AI system 50, executes the function call indicated by the response, and creates the application.

In this manner, the user can create the application by selecting the application type and the management items to be managed in the application via the assistance screen displayed on the user terminal 10.

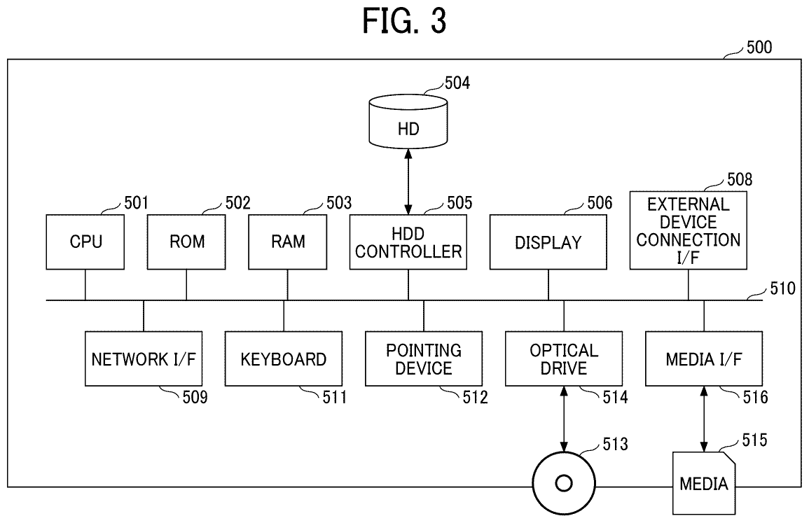

A hardware configuration of the application creation system 100 is described below with reference to FIG. 3.

FIG. 3 is a diagram illustrating an example of a hardware configuration of each of the information processing system 20, the user terminal 10, and the developer terminal 60. As illustrated in FIG. 3, the information processing system 20, the user terminal 10, and the developer terminal 60 are each implemented by a computer 500. The computer 500 includes a central processing unit (CPU) 501, a read-only memory (ROM) 502, a random access memory (RAM) 503, a hard disk (HD) 504, a hard disk drive (HDD) controller 505, a display 506, an external device connection interface (I/F) 508, a network I/F 509, a bus line 510, a keyboard 511, a pointing device 512, an optical drive 514, and a media I/F 516.

The CPU 501 controls overall operation of the computer 500. The ROM 502 stores a program for executing the CPU 501, such as an initial program loader (IPL). The RAM 503 is used as a work area for the CPU 501. The HD 504 stores various data such as software programs. The HDD controller 505 controls reading and writing of various data from and to the HD 504 under control of the CPU 501. The display 506 displays various information such as a cursor, a menu, a window, text, or an image. The external device connection I/F 508 is an interface circuit that connects the computer 500 to various external devices. Examples of the external devices include, but are not limited to, a universal serial bus (USB) memory and a printer.

The network I/F 509 is an interface circuit for performing data transmission using the network N2. The bus line 510 is, for example, an address bus or a data bus for electrically connecting the components illustrated in FIG. 3, such as the CPU 501, with each other.

The keyboard 511 is an example of an input device that includes a plurality of keys for inputting characters, numerical values, various instructions. The pointing device 512 is an example of an input device used to select or execute a specific instruction, select a target for processing, or move a cursor, and may be implemented by a mouse or stylus pen. The optical drive 514 controls reading or writing of various kinds of data from or to an optical disc 513 such as a digital versatile disc-rewritable (DVD-RW), which is an example of a removable recording medium. The removable recording medium is not limited to the DVD-RW and may be, for example, a digital versatile disc recordable (DVD-R). The media I/F 516 controls reading and writing (storing) of data from and to recording media 515 such as a flash memory.

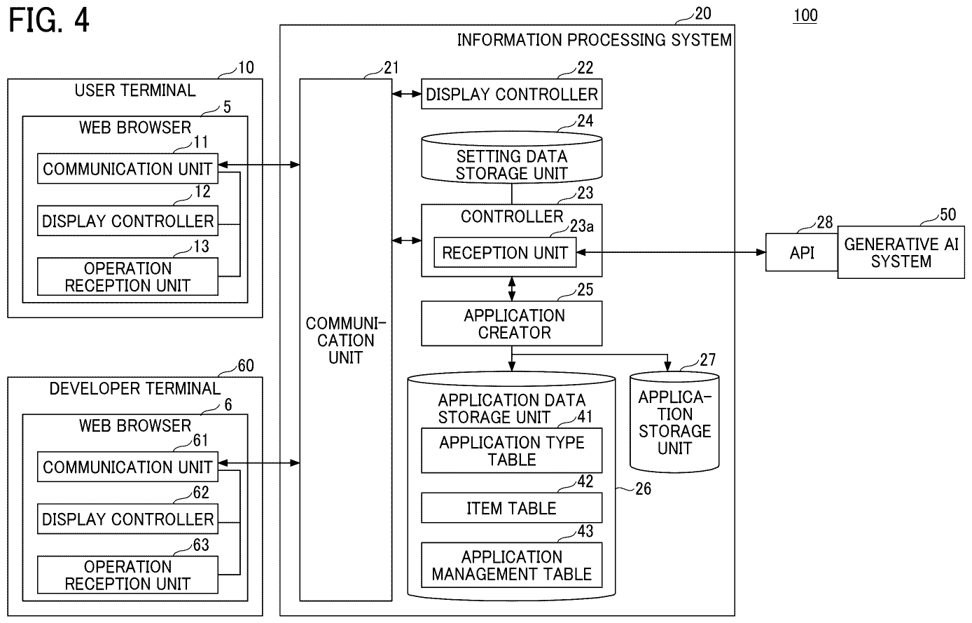

The functions of the information processing system 20, the user terminal 10, and the developer terminal 60 included in the application creation system 100 are described with reference to FIG. 4. FIG. 4 is a diagram illustrating functions performed by each apparatus included in the application creation system 100 according to the first embodiment.

The functions of the information processing system 20 are described. The information processing system 20 includes a communication unit 21, a display controller 22, a controller 23, a setting data storage unit 24, an application creator 25, an application data storage unit 26, and an application storage unit 27. These functional units of the information processing system 20 are functions or means that are implemented by the CPU 501 illustrated in FIG. 3 executing instructions included in one or more programs installed in the information processing system 20.

The setting data storage unit 24, the application data storage unit 26, and the application storage unit 27 are implemented by a memory such as the HD 504 or the RAM 503 illustrated in FIG. 3. The setting data storage unit 24 and the application data storage unit 26 may not be included in the information processing system 20. For example, the setting data storage unit 24 or the application data storage unit 26 may be provided on the network as long as they are accessible by the information processing system 20.

The communication unit 21 transmits and receives various kinds of information to and from the user terminal 10. The communication unit 21 transmits screen information of the assistant screen, which assists the user in creating the application, to the user terminal 10. The communication unit 21 receives information including the application type and the management items input by the user via the assistant screen from the user terminal 10. The communication unit 21 further transmits and receives various types of information to and from the developer terminal 60. The communication unit 21 transmits screen information of an input screen for allowing the developer to input setting data to the developer terminal 60. The communication unit 21 receives the setting data input by the developer from the developer terminal 60, and stores the setting data in the setting data storage unit 24. The communication unit 21 transmits a response message, which is received by the controller 23 from the generative AI system 50, to the user terminal 10.

The display controller 22 generates screen information of a screen (web page), which is displayed by the user terminal 10 or the developer terminal 60.

More specifically, the display controller 22 generates the screen information of the assistant screen that assists the user in creating the application, which is to be displayed on the user terminal 10. The display controller 22 transmits the generated screen information of the assistant screen to the user terminal 10, and causes the user terminal 10 to display the assistant screen. In other words, the display controller 22 causes the user terminal 10 to display a screen that assists the user in creating the application. The screen information of the assistant screen may include an option for receiving a selection of a type of an application to be created and an option for receiving a selection of a management item to be managed by the application.

The option for receiving the selection of the application type is an example of a first option. The selected application type is an example of the first information selected from the first option. The option for receiving the selection of the management item to be managed by the application is an example of a second option. The selected management item is an example of the second information selected from the second option.

The display controller 22 generates screen information of various screens that display the created application on the user terminal 10.

The web page is provided as a part of the web application. The screen information is a program described in, for example, HyperText Markup Language (HTML), JSON, Extensible Markup Language (XML), a script language, or Cascading Style Sheet (CSS). The structure of a web page is mainly specified by HTML, the operation of the web page is defined by a script language, and the style of the web page is specified by CSS.

The controller 23 calls an API 28 to transmit a prompt to the generative AI system 50. The prompt includes the input content that is input on the assistant screen displayed on the user terminal 10, and information that defines the function. The input content input on the assistant screen includes the application type and the management items of the application. In other words, the input content input on the assistant screen includes the information related to the application, which includes the first information and the second information.

The controller 23 includes a reception unit 23a. The API 28 is one or more APIs published by the generative AI system 50. As a result of invoking the API 28, the reception unit 23a of the controller 23 receives a response to the prompt from the generative AI system 50. The response from the generative AI system 50 includes a function call request to the information processing system 20, or a uniform resource locator (URL) of the created or developed application.

The setting data storage unit 24 stores the setting data. The setting data will be described below.

The setting data includes information for the generative AI system 50 to create the application, and includes a function name for identifying the function that defines the process of creating the application.

Specifically, the function defining the creation process is a function that enables the generative AI system 50 to request the information processing system 20 to associate the application having the selected type with the management items managed by the application.

In the present embodiment, the developer terminal 60 operated by the developer instructs to store the setting data in the setting data storage unit 24 before the user starts creating the application. Accordingly, the user does not have to include the parameters of the application in the chat message.

The information processing system 20 generates the prompt to be transmitted to the generative AI system 50, using the setting data. As described above, the developer terminal 60 operated by the developer instructs to store the setting data in the information processing system 20. With this configuration, the user is able to create the application with a simple operation even if the user does not have specialized knowledge about the application.

The setting data is not necessarily used in all cases, and the setting data may not be used depending on the application.

The application creator 25 is implemented by executing a predefined function. The prompt transmitted from the controller 23 to the generative AI system 50 includes information on the application, such as the application type, the name of the management item (field name) managed by the application, and the data format. The application creator 25 creates the application with execution of the function called by the function call included in the responding message, which is received by the controller 23 from the generative AI system 50. The application creator 25 outputs the URL of the application when creation of the application is successful, and outputs an error message when creation of the application fails.

The application creator 25 may generate a macro that operates on spreadsheet software, or may set a field in database software.

The application data storage unit 26 includes an application type table 41, a management item table (“item table”) 42, and an application management table 43. The application type table 41 stores information indicating the type of the application. The management item table 42 is provided for each type of the application, and stores information indicating the management items managed by the application. The application management table 43 stores information used to manage the application created by the application creator 25. The details of each table will be described below.

The application storage unit 27 stores the one or more applications created by the application creator 25.

The functions of the user terminal 10 will be described below. The user terminal 10 includes a communication unit 11, a display controller 12, and an operation reception unit 13, each of which is implemented by a web browser 5. These functional units are functions or means, which are implemented by the CPU 501 illustrated in FIG. 3 executing instructions included in one or more programs installed on the user terminal 10.

For example, the communication unit 11, the display controller 12, and the operation reception unit 13 may be implemented by JavaScript® in web browser 5. Alternatively, the communication unit 11, the display controller 12, and the operation reception unit 13 may be implemented by any script other than JavaScript®.

The communication unit 11 transmits and receives various types of information to and from the information processing system 20. The communication unit 11 receives screen information of a portal screen or the assistant screen from the information processing system 20. The communication unit 11 further receives screen information of a screen to be displayed by the created application from the information processing system 20. The communication unit 11 transmits, to the information processing system 20, the input content input on the assistant screen or operation information indicating the operation performed on the user terminal 10. The communication unit 11 may directly communicate with the generative AI system 50.

The display controller 12 interprets the screen information of various screens and displays the screen information on the display 506. The operation reception unit 13 receives various user operations on various screens displayed on the display 506. The display is an example of a displaying unit of the user terminal 10.

The functions of the developer terminal 60 will be described below. The developer terminal 60 includes a communication unit 61, a display controller 62, and an operation reception unit 63, each of which is implemented by a web browser 6. These functional units are functions or means that are implemented by the CPU 501 illustrated in FIG. 3 executing instructions included in one or more programs installed in the developer terminal 60. For example, the communication unit 61, the display controller 62, and the operation reception unit 63 may be implemented by JavaScript®in web browser 6 or other script in web browser 6. When the developer terminal 60 executes the native application, these functional units may be implemented by the native application.

The communication unit 61 transmits and receives various types of information to and from the information processing system 20. The communication unit 61 receives, from the information processing system 20, screen information used for inputting the setting data. The communication unit 61 transmits the setting data or the operation information, which is received at the developer terminal 60, to the information processing system 20. The communication unit 21 may also directly communicate with the generative AI system 50.

The display controller 62 interprets the screen information of various screens and displays the screen information on the display 506.

The operation reception unit 63 receives various user operations performed on the various screens displayed on the display 506.

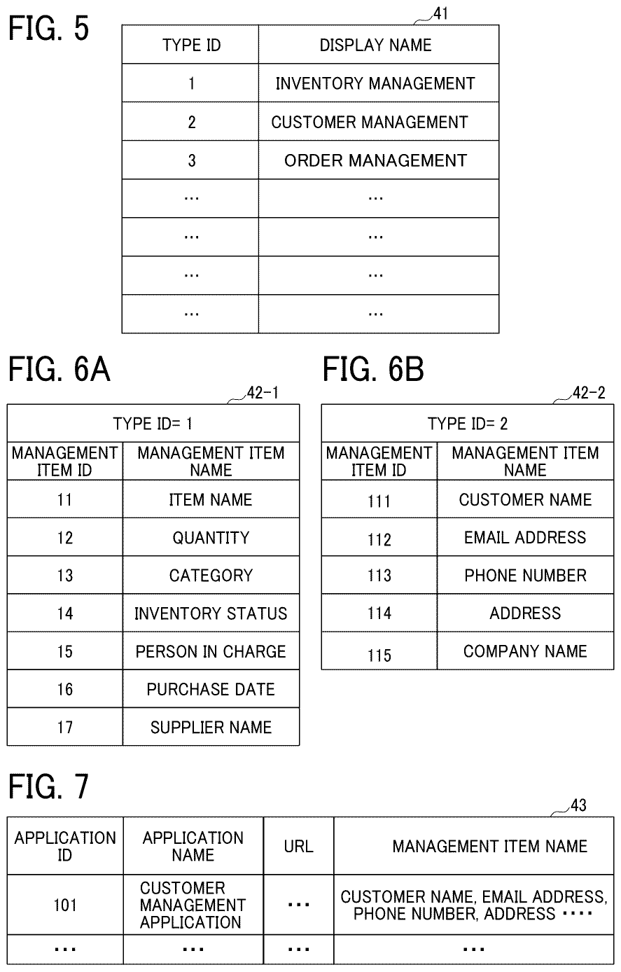

The tables included in the application data storage unit 26 will be described with reference to FIGS. 5 to 7.

FIG. 5 is an example of an application type table 41. The application type table 41 includes, as data items, a type ID and a display name, which are associated with each other. The value of the item “type ID” is identification information for identifying the type of the application. The value of the item “display name” indicates a display name displayed as the type of the application. The type of the application in the application type table 41 may be edited by an administrator of the information processing system 20. The editing includes addition and deletion.

FIGS. 6A and 6B are examples of a management item table. The management item table 42 may be provided for each type of application. The management item table 42-1 of FIG. 6A includes management items managed in the application having the application type identified with the type ID of “1”. The management item table 42-2 of FIG. 6B includes management items managed in the application having the application type identified with the type ID of “2”.

In each of the management item tables 42-1 and 42-2, for each type ID, a management item ID and a management item name are associated with each other for each of the management items managed in the application. Specifically, in the example of FIG. 6B, the management item table 42-2 is for the application of the application type ID “2”. The management items managed in the application type table 41, which is for the customer management application associated with the type ID “2”, include, for example, a customer name, an email address, a phone number, an address, and a company name.

The management items managed in the management item table 42 may be edited by the administrator of the information processing system 20. The editing includes addition and deletion.

FIG. 7 is an example of an application management table 43. The application management table 43 stores application management information used to manage the application created by the application creator 25.

The application management information includes, for example, an application ID, an application name, a URL, and a management item name, as data items. The application ID and the other items are associated with each other.

The value of the item “application ID” is identification information for identifying the created application. The value of the item “application name” indicates the name of the created application. The value of the item “URL” indicates a location of the storage destination where the created application is stored. The application storage destination may be the application storage unit 27 of the information processing system 20 or may be a storage area of a storage device outside the information processing system 20 that can communicate with the information processing system 20. The value of the item “management item name” indicates a management item managed by the created application.

In the present embodiment, each time the application creator 25 creates the application, the application creator 25 stores, in the application management table 43, the application management information for the created application.

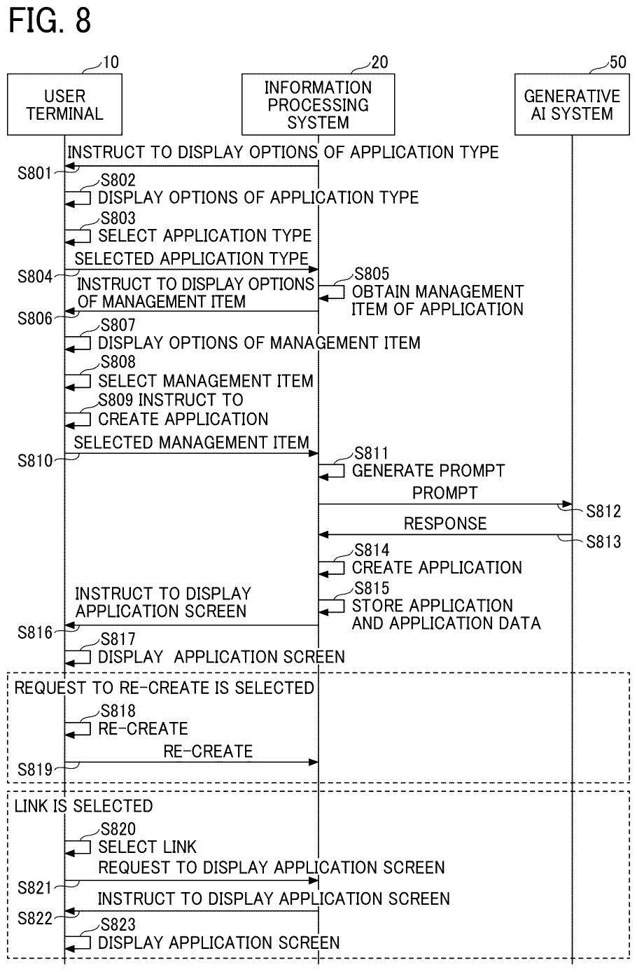

An example operation performed by the application creation system 100 is described below with reference to FIG. 8. FIG. 8 is a sequence diagram illustrating an example operation performed by the application creation system 100 according to the first embodiment.

In response to a request from the user terminal 10, at step S801, the display controller 22 of the information processing system 20 generates screen information of the assistant screen including options of application type, and transmits the generated screen information to the user terminal 10.

More specifically, when the information processing system 20 receives an HTTP request (request) specifying a URL from the user terminal 10 via the communication unit 21, the information processing system 20 transmits the screen information (HTML) of a screen specified by the URL.

When the communication unit 11 of the user terminal 10 receives the screen information (HTML), at step S802, the display controller 12 displays the assistant screen including options of the application type based on the received screen information (HTML).

More specifically, in the user terminal 10, the web browser 5 executes JavaScript® embedded in the screen information (HTML), to display the options of the application type on the display 506.

The options of the application type may be displayed using an input tag of HTML. In such case, JavaScript®for displaying the options of the application type may not be embedded in the screen information (HTML).

When the operation reception unit 13 receives an operation of selecting an application type at step S803, the communication unit 11 transmits a selection result indicating the selected application type to the information processing system 20 at step S804.

More specifically, with execution of JavaScript® embedded in the screen information (HTML), the web browser 5 on the user terminal 10 transmits the selection result indicating the selected application type to the information processing system 20. At this time, the selection result indicating the selected application type includes information for identifying the selected application type, such as a type ID of the selected application type or a display name of the selected application type. The user terminal 10 transmits the selection result indicating the selected application type, for example, in the form of an HTTP request.

In the information processing system 20, when the communication unit 21 receives the selection result indicating the selected application type, at step S805, the application creator 25 refers to the management item table 42 of the application data storage unit 26, and acquires the management items corresponding to the type ID of the selected application type indicated by the selection result. The selection result indicating the selected application type may include a display name of the selected application type instead of the type ID of the selected application type. In such case, the management items are associated with the display name of the application type in the management item table 42, instead of being associated with the type ID of the application type.

Although FIG. 8 illustrates the example case in which the information processing system 20 acquires the management items of the application, the user terminal 10 may acquire the management items of the application. Specifically, the user terminal 10 may include an edge AI, such as an AI model having learned the association between the application type and the management items. In such case, the processes performed through the steps S804 to S806 are not performed. Instead, the application type selected at S803 is input to the edge AI included in the user terminal 10. The user terminal 10 then acquires the management items output from the edge AI. At step S807, the user terminal 10 displays the assistant screen including the acquired management items.

In this embodiment, the selection result indicating the selected application type transmitted from the user terminal 10 to the information processing system 20 includes the first information for identifying the type selected from the first option.

In the example of FIG. 8, the application creator 25 refers to the management item table 42 to acquire the management items, but the present disclosure is not limited thereto. For example, the controller 23 of the information processing system 20 may generate a prompt that requests listing of candidates for management items managed in the application having the selected type, and transmit the prompt to the generative AI system 50. The controller 23 then acquires the candidate of management items included in the response message from the generative AI system 50 received at the reception unit 23a, and passes the candidate of management items to the application creator 25.

Subsequently, at step S806, the display controller 22 of the information processing system 20 generates screen information of the assistant screen including the candidates of management items corresponding to the selected application type, and transmits the generated screen information to the user terminal 10. When the communication unit 11 receives the screen information, at step S807, the display controller 12 displays the assistant screen including the candidates of management items corresponding to the application type based on the received screen information.

In another example, the information processing system 20 transmits the screen information of the entire screen including the options of the application type and the options of the management item to the user terminal 10. The information process system 20 embeds JavaScript® for displaying the options of the management item corresponding to the application type, in the screen information transmitted to the user terminal 10 at step S801. In such case, when the application type is selected, the web browser 5 of the user terminal 10 executes the JavaScript®to request the information processing system 20 for the management items corresponding to the application type, and displays the options of the management item acquired from the information processing system 20.

At step S808, the operation reception unit 13 receives an operation of selecting the management item. When the operation reception unit 13 receives the operation of instructing creation of the application at step S809, the communication unit 11 transmits the selection result indicating the selected management items to the information processing system 20 at step S810.

The selection result transmitted from the user terminal 10 to the information processing system 20 may include the management item ID or the management item name for identifying each of the management items selected on the assistant screen. In other words, the selection result transmitted from the user terminal 10 to the information processing system 20 includes the second information for identifying the item selected from the second option.

When the communication unit 21 receives the selection result of the management item, the controller 23 of the information process system 20 generates a prompt at step S811, and transmits the prompt to the generative AI system 50 at step S812.

The generated prompt includes the first information for identifying the type selected from the first option, the second information for identifying the management item selected from the second option, and the setting data used to create the application. In other words, the generated prompt includes the first information, the second information, and the function name for identifying the function that causes the application creator 25 to perform the specific function.

Specifically, the controller 23 transmits the function name for identifying the function that causes the application creator 25 to perform the specific function to the generative AI system 50 at least once. The details of the generated prompt will be described below.

At step S813, in the information process system 20, the reception unit 23a of the controller 23 receives the response message from the generative AI system 50. The response message that is received is a request generated by the generative AI system 50, which includes the function name for identifying the function that causes the application creator 25 to perform the specific function.

At step S814, the application creator 25 creates the application according to the response message. Specifically, the application creator 25 creates the application with execution of the function identified by the function name included in the response message. At step S815, the application creator 25 stores the created application in the application storage unit 27, and further stores the application management information of the created application in the application management table 43.

At step S816, the information processing system 20 generates screen information including the result of the created application, and transmits the generated screen information to the user terminal 10. At step S817, at the user terminal 10, the communication unit 11 receives the screen information, and the display controller 12 displays an application creation result screen indicating the created application. The application creation result screen being displayed may include a URL indicating a storage destination of the created application and an operation button for requesting re-creation of the application.

The following steps S818 and S819 are processes performed when the user terminal 10 receives a user instruction to re-create the application on the application creation result screen displayed at S817.

When the operation reception unit 13 receives the operation to instruct to re-create the application at step S818, the user terminal 10 transmits a request to re-create the application to the information processing system 20 at step S819. In response to receiving the request for re-creating the application, the information processing system 20 returns the operation to step S801 and repeats the creating process, which corresponds to the steps S801 to S817.

The following processes from step S820 to step S823 are performed in the case where the URL, which is the storage destination of the application, is selected on the application creation result screen being displayed at S817.

When the operation reception unit 13 receives an operation of selecting the URL that is the storage destination of the application at step S820, at step S821, the user terminal 10 transmits a request for displaying an application screen for the created application to the information processing system 20.

In response to receiving the request for displaying the application screen via the communication unit 21, at step S822, the information processing system 20 generates screen information of the application screen and transmits the generated screen information to the user terminal 10. When the communication unit 11 receives the screen information, at step S823, the display controller 12 displays the application screen based on the received screen information.

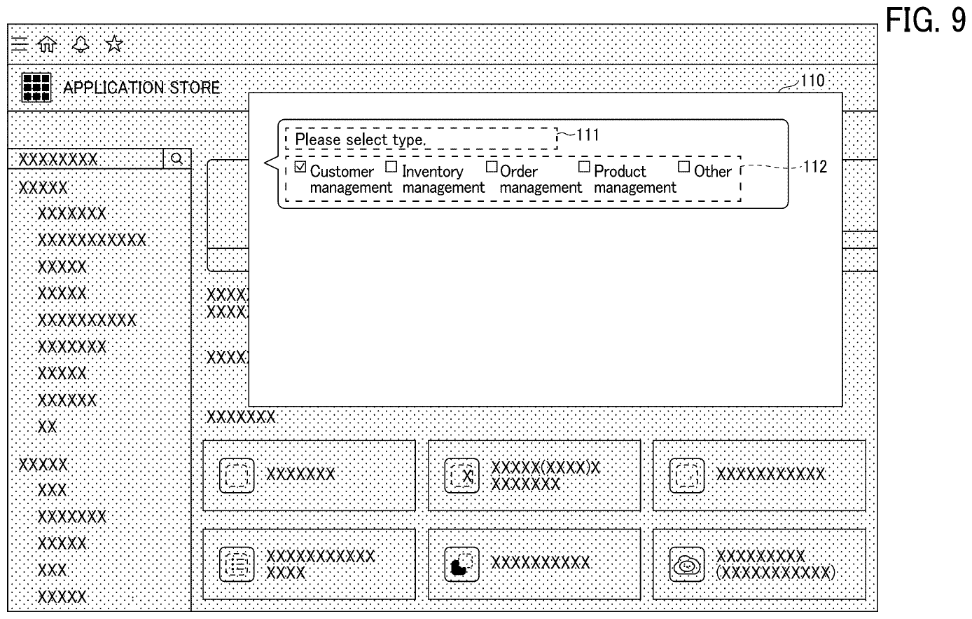

An example of a screen displayed by the user terminal 10 will be described below. FIG. 9 is a diagram illustrating a first example of a screen displayed on the user terminal 10 according to the first embodiment. A screen 110 illustrated in FIG. 9 is an example of the assistant screen displayed on the user terminal 10 at step S802 of FIG. 8.

For example, the screen 110 is displayed as a pop-up window on a home screen of the application creation system 100 displayed on the user terminal 10.

The screen 110 includes display areas 111 and 112. The display area 111 includes a message prompting the user to select the application type. The display area 112 includes a list of application types for selection by the user. More specifically, the display area 112 includes a list of the display names of the application types, which are stored in the application type table 41, in a selectable manner. In other words, the display area 112 displays the first option for receiving the selection of the application type.

The display area 112 illustrated in FIG. 9 includes the display names of the application types and the check boxes in association. The application type having the display name, which is associated with the check box that is checked by the user, is selected. In the example of FIG. 9, a check is input to the checkbox associated with the application type “customer management”. This indicates that the application type “customer management” is selected.

As described above, the first option is displayed as a list of the display names of the application types and the operation components that are associated with each other. From the first option, the application type having the display name associated with the selected operation component is selected as the type of the application to be created.

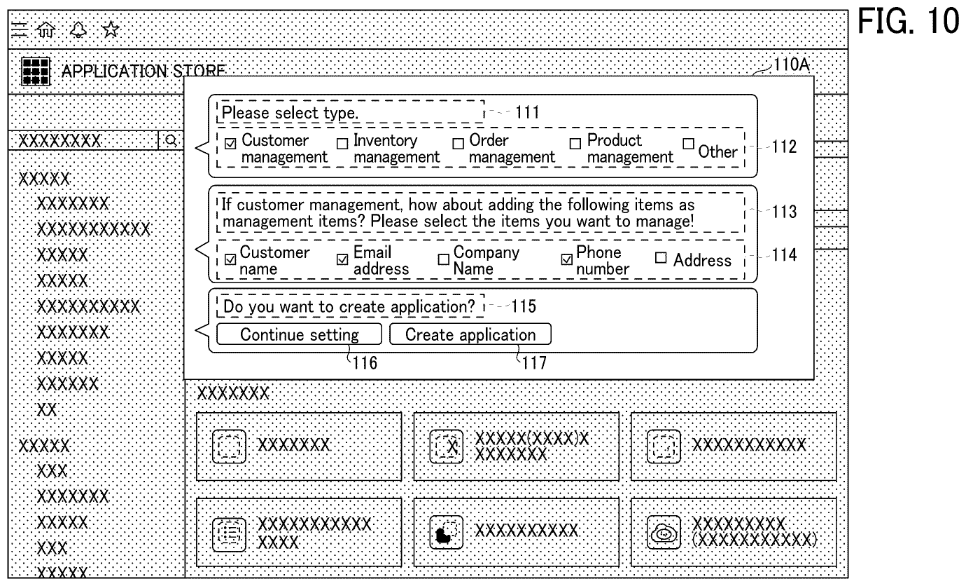

FIG. 10 is a diagram illustrating a second example of a screen displayed on the user terminal 10 according to the first embodiment. The screen 110A of FIG. 10 is an example of the assist screen displayed on the user terminal 10 at step S807 of FIG. 8. FIG. 10 illustrates the example case in which the application type “customer management” is selected on the screen 110 illustrated in FIG. 9.

The screen 110A includes display areas 111, 112, 113, 114, and 115, and operation buttons 116 and 117. The display area 113 includes a message prompting the user to select one or more management items to be managed in the application having the application type of “customer management”.

The display area 114 includes a list of management item names associated with the application type “customer management” in the management item table 42 for selection by the user. Specifically, the display area 114 displays the second option for receiving the selection of one or more management items to be managed in the customer management application, from the list of candidates for management items that can be managed in the customer management application.

As described above, the second option is displayed as a list of the management item names and the operation components that are associated with each other. From the second option, the management item having the management item name associated with the selected operation component is selected as the management item to be managed by the created application.

The display area 114 of FIG. 10 includes five management item names included in the management item table 42-2 associated with the application type “customer management”, and the check boxes in association. The management item having the management item name, which is associated with the check box that is checked by the user, is selected.

In the display area 114 of FIG. 10, the customer name, the email address, and the phone number are selected.

In FIG. 10, the number of management items displayed in the display area 114 is five, but the number of management items is not limited thereto. For example, in the case of transmitting the prompt for requesting listing of the candidates for management item to the generative AI system 50 at step S805, the display area 114 may display all of the management item names acquired as a response from the generative AI system 50. In this case, the display area 114 displays the management item names included in the management item table 42 corresponding to the application type, and the management item names other than the management item names included in the management item table 42.

The display area 115 includes a message prompting the user to instruct creation of the application. The operation button 116 is pressed when the selection of the application type or the selection of the management item is to be re-done. In response to pressing of the operation button 116, the checks input to the check box in the display areas 112 and 114 are deleted.

The operation button 117 is pressed when an instruction to create the application is to be transmitted to the information processing system 20. In response to pressing of the operation button 117, the user terminal 10 transmits the one or more management items for which the check box is checked in the display area 114 to the information processing system 20 with the instruction to create the application.

When the information processing system 20 receives the instruction to create the application from the user terminal 10, the information processing system 20 generates a prompt including the selected application type and the selected management items, and transmits the prompt to the generative AI system 50.

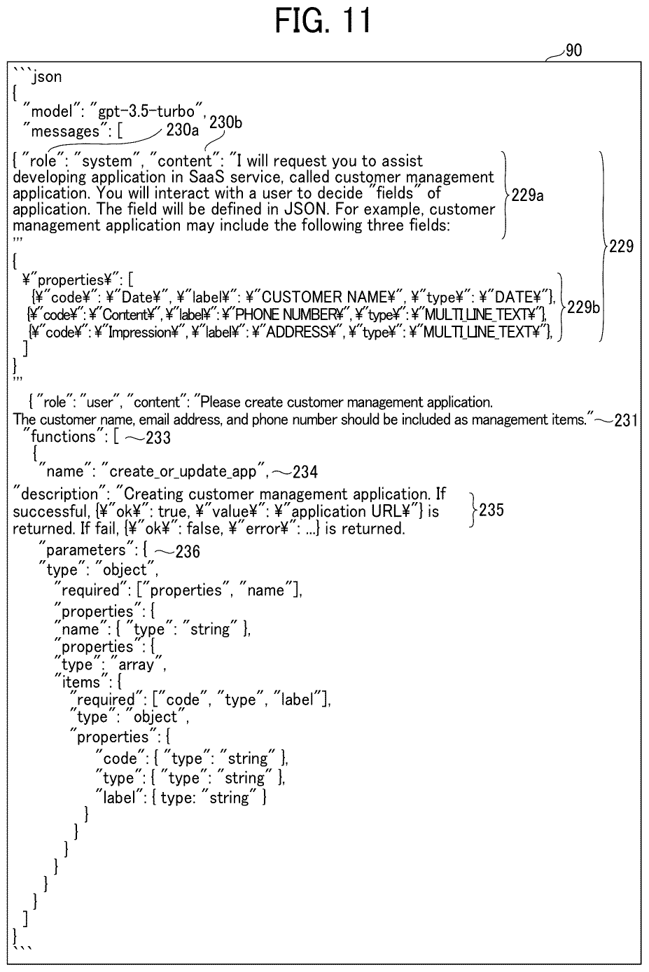

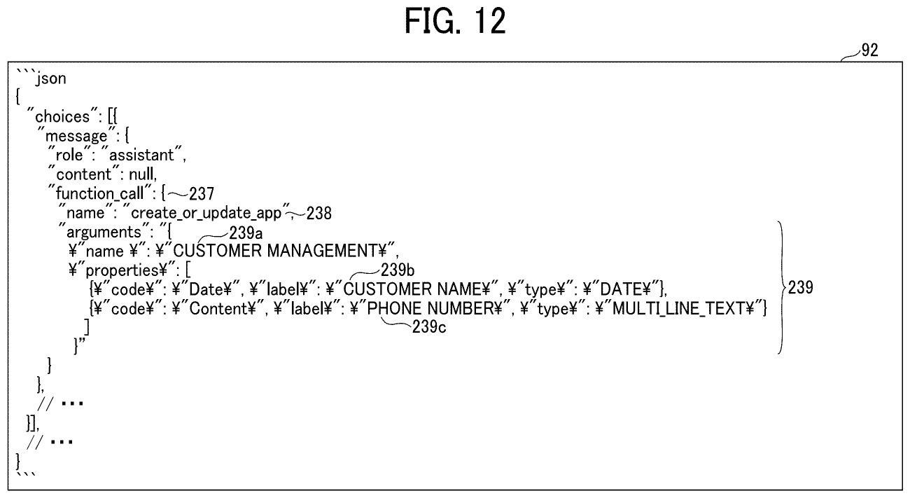

The example of the prompt transmitted from the information processing system 20 to the generative AI system 50 will be described below with reference to FIG. 11. FIG. 11 is a diagram illustrating an example of the prompt.

The prompt 90 illustrated in FIG. 11 is an example of a prompt generated by the controller 23 at step S811 of FIG. 8, and transmitted to the generative AI system 50.

The prompt 90 includes role 230a and content 230b. The role 230a indicates a speaker, and includes “user”, “assistant” (AI of the generative AI system 50), and “system” (instructing settings of AI assistant). The content 230b indicates the conversation contents, and may be written in the natural language.

For example, the speaker indicated by the role 230a may be the information processing system 20, and the conversation contents indicated by the content 230b may be the contents previously set in the information processing system 20.

The prompt 90 further includes system setting 229 by the system. The system setting 229 includes an application type that is the first information selected from the first option. The system setting 229 may include data 229a, which is a message “I will request you to assist developing application in SaaS service, called customer management application. You will interact with a user to decide “fields” of application. The field will be defined in JSON. For example, customer management application may include the following three fields”.

The system setting 229 includes a management item (field name) of the application that is the second information selected from the second option. The system setting 229 further includes data 229b indicating the fields “customer name”, “phone number”, and “address” as field names. The data formats of these fields are respectively set to DATE, MULTI_LINE_TEXT, and MULTI_LINE_TEXT. The data 229a and the data 229b are based on the setting data, which is previously transmitted to the information processing system 20 according to an instruction from the developer.

The prompt 90 further includes a text message 231 that requests to include the management items selected by the user in the management items of the customer management application. An example of such text message 231 is “Please create customer management application. The customer name, email address, and phone number should be included as management items”. This text message may be generated by inserting the application type and the management items that are selected at the user terminal 10 into a template stored in the application creator 25. Alternatively, the text message may be input by the user at the user terminal 10.

The prompt 90 of FIG. 11 further includes a function specification setting 233, which is represented as “functions”. In the function specification setting 233, name 234 is the name of the function. description 235 indicates the specification of the function. In detail, the specification instructs the generative AI system 50 to return a URL when the creation of the application is successful, and return an error message when the creation of the application fails. parameters 236 is also a part of the specification of the function. “type”: “object” indicates the data format of the return value. “required”: [“properties”, “name”] indicates the item name required for the return value. “name”: {“type”: “string”} indicates the data format of name. “type”: “array” indicates that the format is a table format. “items” and the description below “items” indicate the attributes and data types required for the field.

With the function specification setting 233, the generative AI system 50 returns a response requesting the information processing system 20 to call a function defined as illustrated in FIG. 11.

An example of a response from the generative AI system 50 to the information processing system 20 will be described below with reference to FIG. 12.

FIG. 12 is a diagram illustrating an example of a response message 92 transmitted from the generative AI system 50 in response to the prompt. The response message 92 illustrated in FIG. 12 is output from the generative AI system 50 to the information processing system 20 at step S813 of FIG. 8.

The response message 92 includes a function call request 237. When the function call is included in the response message, the information processing system 20 generates an application.

The function call request 237 of the response message corresponds to the request to create the application. The function call request 237 includes name 238 and arguments 239. The name 238 is the name of the function defined in the function specification setting 233. The generative AI system 50 requests the information processing system 20 to call the function having this name. arguments 239 is a return value, and is defined in the function specification setting 233. In FIG. 12, the arguments 239, which are the return value, include the application name “customer management” 239a, the field names 239b and 239c included in the customer management application, and the data types (DATE, MULTI_LINE _TEXT) of these fields.

Although omitted in FIG. 12, the response message 92 includes all of the management item names included in the prompt 90 illustrated in FIG. 11 as the field names.

The generative AI system 50 designates the field names (management item names) selected at the user terminal 10 using the function call, and requests the information processing system 20 to call the function for creating the application.

The information processing system 20 analyzes the function call included in the response message 92 and creates the application (execution of a function). Specifically, the information processing system 20 creates the application using the field names and the data formats (an example of parameters) included in the response message 92. When the creation of the application is successful, the information processing system 20 acquires a URL that is a storage destination of the application, and transmits the URL to the user terminal 10. The URL is access information for the user terminal 10 to access the application.

When the information processing system 20 receives the response message 92 illustrated in FIG. 12, the application creator 25 creates the customer management application and displays the application creation result on the user terminal 10.

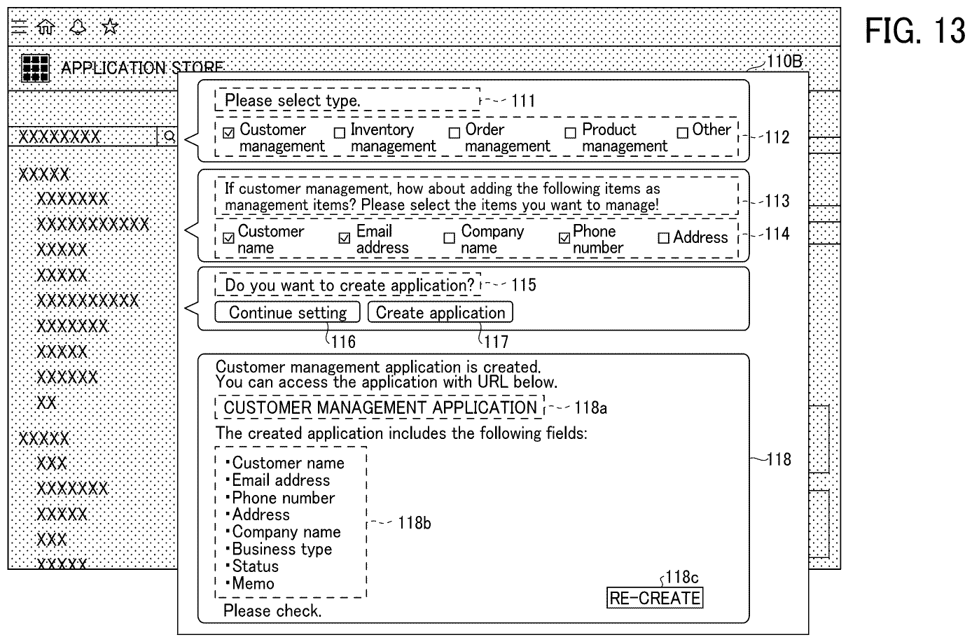

Operation of displaying the application creation result is described below with reference to FIG. 13. FIG. 13 is a diagram illustrating a third example of a screen displayed on the user terminal 10 according to the first embodiment.

The screen 110B illustrated in FIG. 13 is an example of the screen displayed on the user terminal 10 at step S817 of FIG. 8. Specifically, the screen 110B of FIG. 13 displays the application creation result in the case where the customer management application is successfully created. The screen 110B of FIG. 13 is displayed on the user terminal 10, when the operation button 117 is selected while “customer name”, “email address”, and “phone number” are selected as the management items in the screen 110A of FIG. 10.

The screen 110B includes display areas 111, 112, 113, 114, and 115, the operation buttons 116 and 117, and a display area 118.

The display area 118 displays the creation result information indicating a result of creating the application. The creation result information indicating the result of creating the application may include a message indicating that the customer management application has been created, information indicating the storage destination of the customer management application, and the management items of the customer management application.

The display area 118 includes display areas 118a and 118b and an operation button 118c. The display area 118a includes a URL, which is information indicating a storage destination of the customer management application. When the URL displayed in the display area 118a is selected, the user terminal 10 displays an application screen of the customer management application. The application screen will be described below in detail.

The display area 118b includes the names of the management items included in the created customer management application. In the example of FIG. 13, the customer management application includes, as the management item names, a customer name, an email address, a phone number, an address, a company name, a business type, a status, and a memo.

The management item names “company name” and “address” are management item names that are stored in the management item table 42-2 but are not selected by the user. The management item names “business type”, “status”, and “memo” are management item names that are not included in the management item table 42-2, and are management item names added by the generative AI system 50 to which the prompt 90 is input.

In this way, in addition to the management items selected by the user and the management items stored in the management item table 42, the other management items may be included as the management items of the created application according to the response from the generative AI system 50.

The operation button 118c, when selected, allows the user to re-create the application. When the operation button 118c is pressed on the screen 110B, the screen 110B of FIG. 13 is switched to the screen 110 of FIG. 9 to re-create the application.

FIG. 13 illustrates the display example of the application creation result when creation of the application is successful. When the creation of the application fails, the display area 118 of the screen 110b may display an error message indicating that the creation of the application fails.

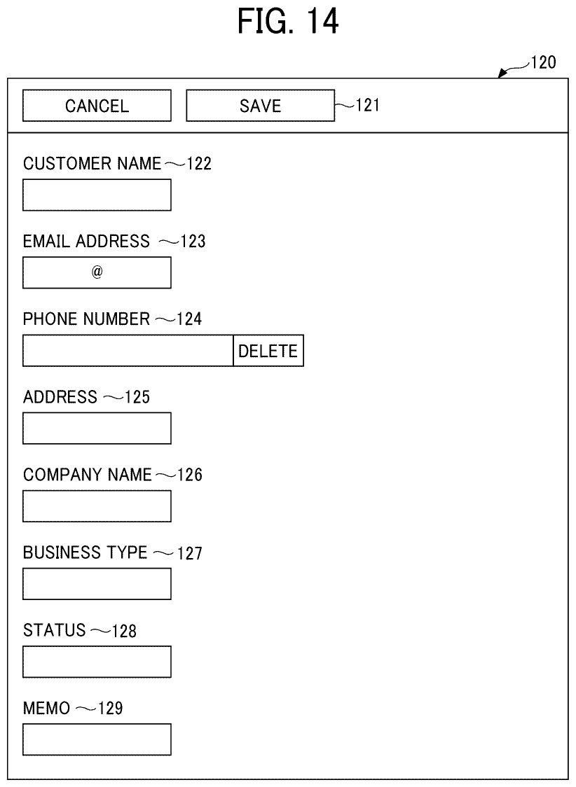

An application screen of the customer management application will be described below with reference to FIG. 14. FIG. 14 is a diagram illustrating a fourth example of a screen displayed on the user terminal 10 according to the first embodiment. The screen 120 illustrated in FIG. 14 is an example of the screen displayed on the user terminal 10 at step S823 of FIG. 8.

The screen 120 includes an operation button 121 and input fields 122, 123, 124, 125, 126, 127, 128, and 129. The input field 122 is an input field for entering the management item “customer name”. The input field 123 is an input field for entering the management item “email address”. The input field 124 is an input field for entering the management item “phone number”. The input field 125 is an input field for entering the management item “address”. The input field 126 is an input field for entering the management item “customer name”. The input field 127 is an input field for entering the management item “business type”. The input field 128 is an input field for entering the management item “status”. The input field 129 is an input field for entering the management item “memo”.

When the value of the management item is input to each input field of the screen 120 and the operation button 121 is pressed, the user terminal 10 transmits, to the information processing system 20, the customer management information in which the management items and the input values are associated. The customer management information is stored in the information processing system 20. For example, the customer management information is stored in the application data storage unit 26 in association with the customer management application.

To use the customer management application, the user may call the customer management application from a home screen of the application creation system 100 displayed on the user terminal 10. When calling the customer management application, the application creation system 100 may refer to the customer management information associated with the customer management application.

In this way, the user does not need to consider a text message to be included in the prompt, and can create the application only by selecting the application type and the management items.

Further, the application type and the options of the management items are presented to the user. Even if the user does not have an idea of specific application type or specific management items, the application can be generated only by selecting a desired application type and desired management items from the options.

### Second Embodiment

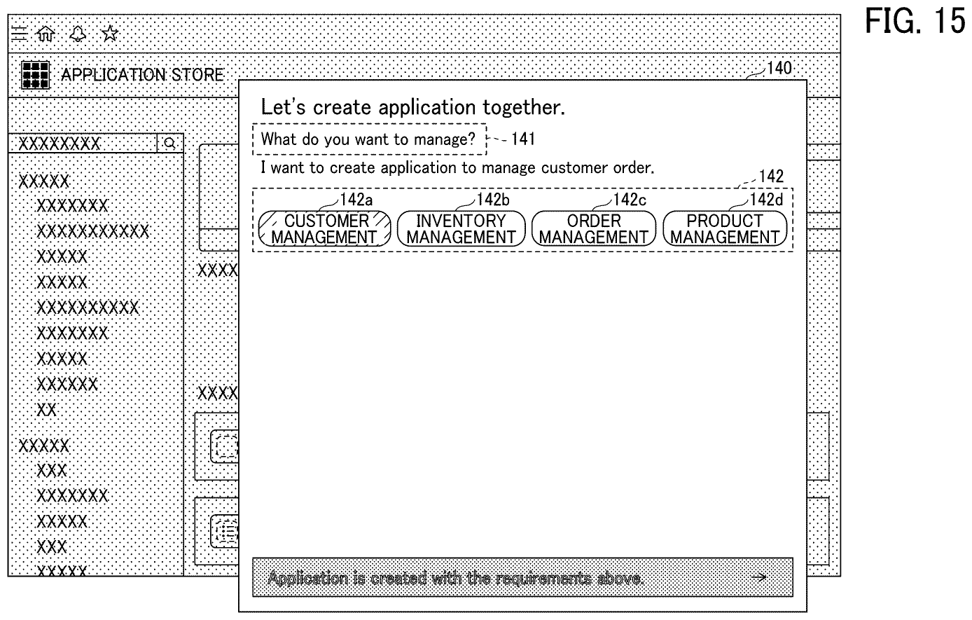

The application creation system according to the second embodiment is described below with reference to FIGS. 15 to 17. The differences between the first embodiment and the second embodiment include display forms of the application type and the options of the management items. In the following description of the second embodiment, the differences from the first example are described. The same reference numerals are given to the same or corresponding functions or configurations as those of the first embodiment, and redundant descriptions thereof are omitted or simplified as appropriate.

FIG. 15 is a diagram illustrating a first example of a screen displayed on the user terminal 10 according to the second embodiment. A screen 140 illustrated in FIG. 15 is an example of the assistant screen displayed on the user terminal 10 at step S802 of FIG. 8.

The screen 140 includes display areas 141 and 142. The display area 141 includes a message prompting the user to select the application type. In the display area 142, a list of application types is displayed as a list of operation buttons associated with the application types.

In other words, the first option is displayed as a list of operation components represented by the display names of the application types. From the first option, the application type having the display name displayed on the selected operation component is selected as the type of the application to be created.

Specifically, the display area 142 includes operation buttons 142a, 142b, 142c, and 142d. The operation buttons 142a, 142b, 142c, and 142d are each displayed with the display name of the application type.

Since the options of the application type are displayed each as the operation button, the application type can be easily selected by pressing a specific operation button.

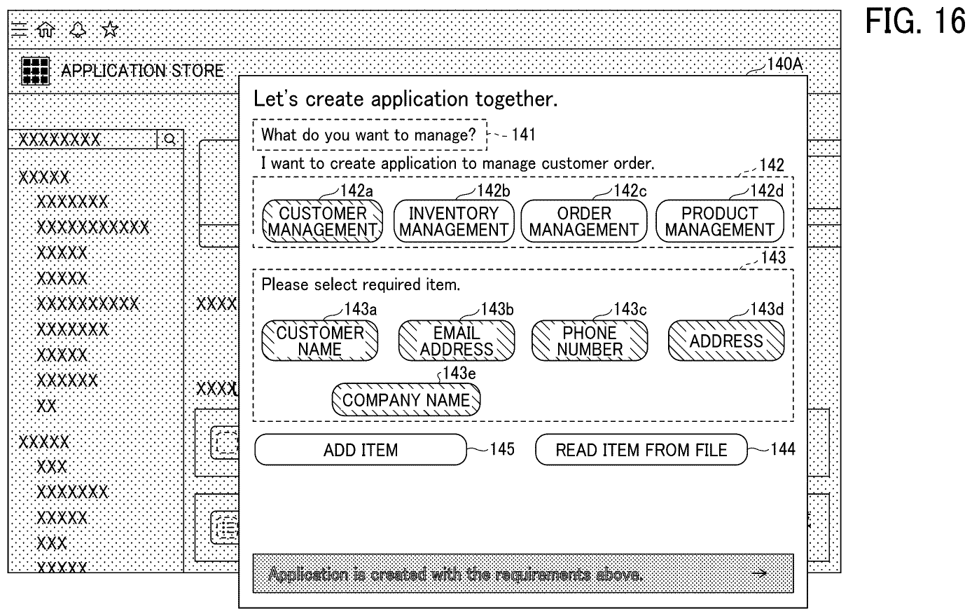

FIG. 16 is a diagram illustrating a second example of a screen displayed on the user terminal 10 according to the second embodiment. The screen 140A illustrated in FIG. 16 is an example of the assistant screen displayed on the user terminal 10 at step S807 of FIG. 8. The screen 140A is an example of the assistant screen displayed on the user terminal 10 when the operation button 142a with the display name “customer management” is pressed on the screen 140 illustrated in FIG. 15.

The screen 140A includes display areas 141, 142, and 143, and operation buttons 144 and 145. In the display area 143, a list of management item names associated with the application type “customer management” in the management item table 42 is displayed as a list of operation buttons associated with the management items.

In other words, the second option is displayed as a list of operation components represented by the management item names of the management items. From the second option, the management item having the management item name displayed on the selected operation component is selected as the management item to be managed by the created application.

Specifically, the display area 143 includes operation buttons 143a, 143b, 143c, 143d, and 143e. The management item names stored in the management item table 42-2 are displayed on the operation buttons 143a, 143b, 143c, 143d, and 143e, respectively.

As described above, a list of the operation components having the management item names are displayed as options of the management items.

Since the options of the management items are displayed each as the operation button, the management item can be easily selected by pressing a specific operation button.

The operation button 144 is an operation button that allows the user to add an item name read from a data file selected at the user terminal 10, to the list of management item names displayed in the display area 143. The data file may have a table format, such as spreadsheet. When the operation button 144 is selected on the screen 140A, the user terminal 10 may display a screen including a list of data files each having a table format. The user terminal 10 adds the item name of the item included in the data file selected from the displayed list, to the list of the management item names displayed in the display area 143.

The operation button 145 is an operation button that allows the user to add a management item name of the other management item, to the management item name displayed in the display area 143. When the operation button 145 is selected on the screen 140A, the user terminal 10 adds the management item name of the other management item, to the list of management item names displayed in the display area 143.

In one example, the other management item names include management item names that are not displayed in the display area 143, from among the management item names included in the management item table 42-2 corresponding to the application type “customer management”. In another example, the other management item names include management item names included in the management item table 42 other than the management item table 42-2 corresponding to the application type “customer management”.

Further, the management item names of the management items to be added to the list of management item names displayed in the display area 143 may be acquired from the generative AI system 50.

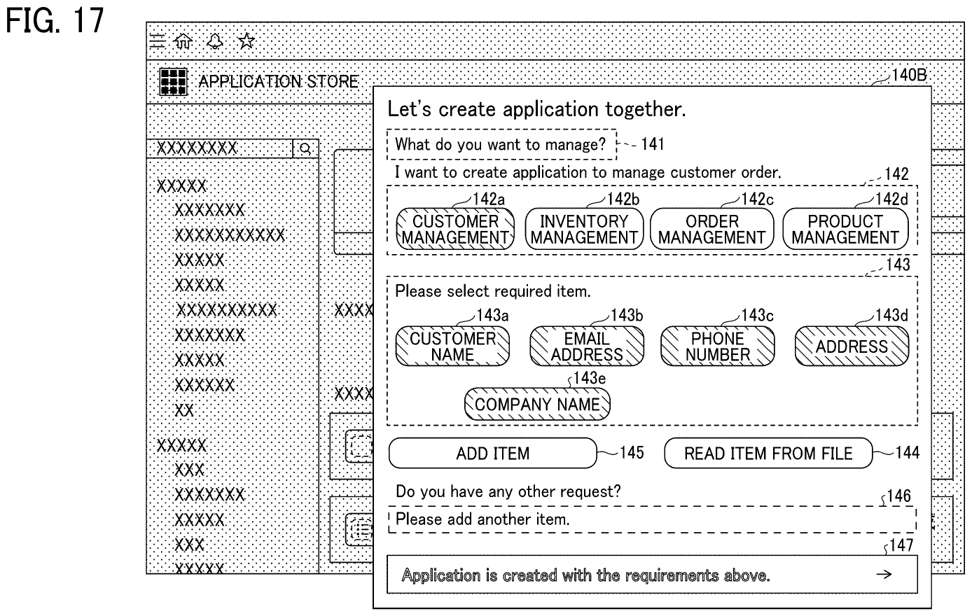

FIG. 17 is a diagram illustrating a third example of a screen displayed on the user terminal 10 according to the second embodiment. The screen 140B illustrated in FIG. 17 is an example of a screen displayed when the operation button 145 is selected on the screen 140A illustrated in FIG. 16.

The screen 140B includes display areas 141, 142, and 143, operation buttons 144 and 145, an input field 146, and an operation button 147.

A message, which requests to acquire the management item to be displayed in the display area 143 from the response message of the generative AI system 50, is input to the input field 146. For example, when the message such as “Please add another item” is input to the input field 146, the user terminal 10 transmits this message to the information processing system 20.

When the information process system 20 receives the message, the controller 23 generates a prompt including the received message, and transmits the prompt to the generative AI system 50. The reception unit 23a receives a response message from the generative AI system 50. The display controller 22 of the information processing system 20 may display the management items included in the response message in the display area 143.

Accordingly, the management items acquired from the generative AI system 50 can be included in the options of the management items managed by the application.

The operation button 147 is pressed when an instruction to create the application is to be transmitted to the information processing system 20. When the operation button 147 is selected, the user terminal 10 transmits, to the information processing system 20, the management item identified with the management item name that is displayed on the operation button selected in the display area 143, with the instruction to create the application.

When the creation result information indicating the result of creating the application is received from the information processing system 20, the user terminal 10 may display the creation result information in a lower portion of the operation button 147 of the screen 140B, in substantially the same manner as the display area 118 of the screen 110B of FIG. 13.

As described above, the operation button for selecting the application type or the management items is made larger than the checkbox, such that the user can easily select the application type or the management items.

### Third Embodiment

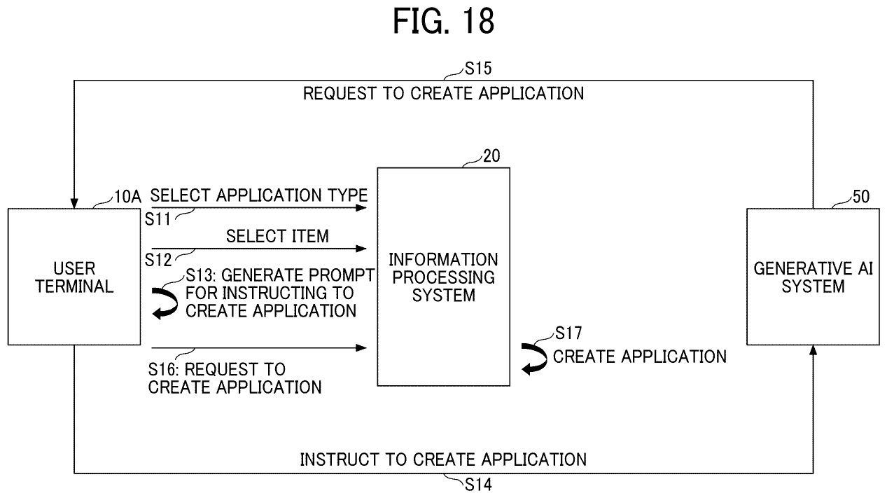

An application creation system 100A according to the third embodiment is described below with reference to FIGS. 18 to 20. The differences between the application creation system 100 of the first embodiment and the application creation system 100A of the third embodiment include that a prompt to be transmitted to the generative AI system 50 is generated at a user terminal 10A. In the following description of the third embodiment, differences from the first embodiment are described. The same reference numerals are given to the same or corresponding functions or configurations as those of the first embodiment, and redundant descriptions thereof are omitted or simplified appropriately.

FIG. 18 is a diagram illustrating operation performed by the application creation system 100A according to the third embodiment.

The processes of step S11 and step S12 in FIG. 18 are the same as the processes of step S1 and step S2 in FIG. 2, and the description thereof is omitted.

In the application creation system 100A, when the management items are selected, at step S13, the user terminal 10A generates a prompt for instructing the generative AI system 50 to create the application. At step S14, the user terminal 10A transmits the generated prompt to the generative AI system 50. The prompt transmitted to the generative AI system 50 includes information related to the application and the setting of the specification of the function.

When the generative AI system 50 receives the prompt from the user terminal 10A, at step S15, the generative AI system 50 transmits an application creation request to the user terminal 10A based on the information related to the application and the setting data of the specification of the function included in the prompt. More specifically, the generative AI system 50 transmits, as the application creation request, a response including a function call request (function call) to the user terminal 10A.

At step S16, the user terminal 10A transmits the application creation request received from the generative AI system 50 to the information processing system 20. At step S17, the information processing system 20 creates the application in response to reception of the application creation request.

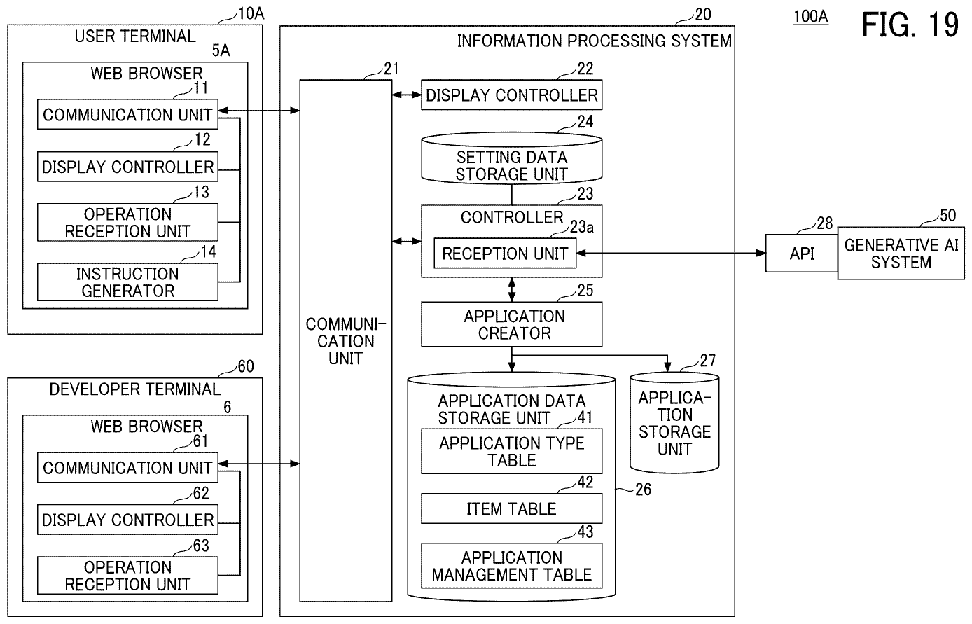

The functions of the information processing system 20, the user terminal 10A, and the developer terminal 60 included in the application creation system 100A are described below with reference to FIG. 19. FIG. 19 is a diagram illustrating functions performed by each apparatus included in the application creation system 100A according to the third embodiment.

The application creation system 100A includes the user terminal 10A, the information processing system 20, the generative AI system 50, and the developer terminal 60. The information processing system 20, the generative AI system 50, and the developer terminal 60 are substantially similar in function to those described above in first embodiment.

The user terminal 10A includes a communication unit 11, a display controller 12, an operation reception unit 13, and an instruction generator 14, each of which is implemented by a web browser 5A.

The display controller 12 and the operation reception unit 13 are substantially similar in function to those described above referring to FIG. 4.

The communication unit 11 communicates with the information processing system 20 and the generative AI system 50. The communication unit 11 is an example of a first communication unit that communicates with the generative AI system 50. Further, the communication unit 11 is an example of a second communication unit that communicates with the information processing system 20.

The communication unit 21 of the information processing system 20 is an example of a third communication unit that communicates with the user terminal 10A.

The instruction generator 14 generates a prompt to be transmitted to the generative AI system 50 according to an operation on the user terminal 10A. In other words, the instruction generator 14 generates an instruction to be transmitted to the generative AI system.

The instruction generator 14 may be implemented by JavaScript®. For example, the JavaScript that operates as the instruction generator 14 may be embedded in the screen information for displaying the screen 110 or the screen 110A on the user terminal 10A at step S807 of FIG. 8.

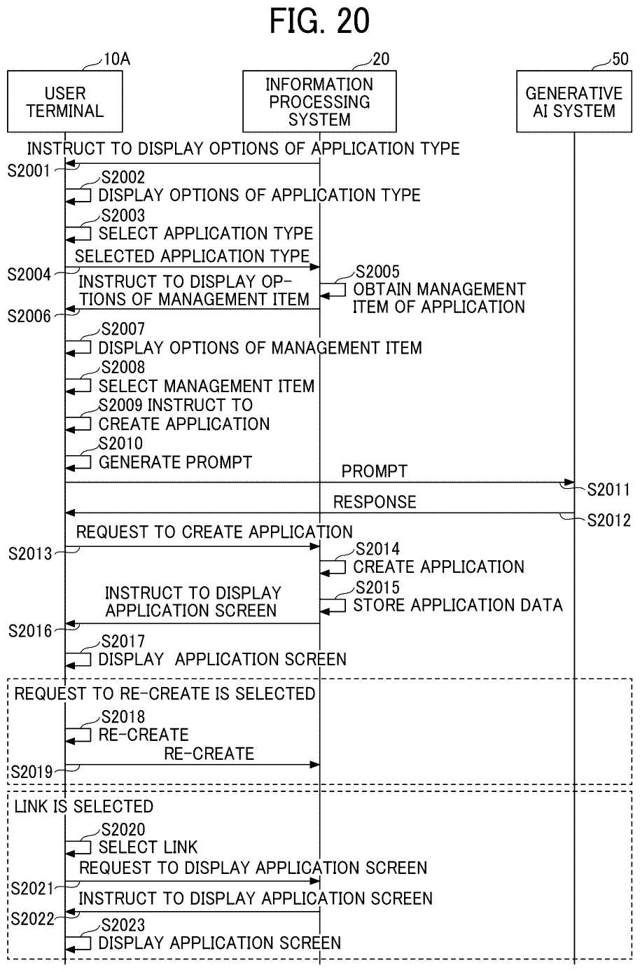

An operation performed by the application creation system 100A of the third embodiment will be described below with reference to FIG. 20. FIG. 20 is a sequence diagram illustrating an example operation performed by the application creation system 100A according to the third embodiment.

Since the processes from step S2001 to step S2009 of FIG. 20 are substantially the same as the processes from step S801 to step S809 of FIG. 8, description thereof is omitted.

The assistant screen displayed on the user terminal 10A at step S2007 is, for example, the screen 110A of FIG. 10. In the present embodiment, JavaScript®that creates the application may be embedded in the screen information for displaying the screen 110A.

The screen information received by the user terminal 10A from the information processing system 20 may include a program for generating a prompt to be transmitted to the generative AI system 50, a program for transmitting the generated prompt to the generative AI system 50, and a program for transmitting an application creation request to the information processing system 20 in response to a response message from the generative AI system 50.

In the user terminal 10A, when the operation reception unit 13 receives an operation of instructing creation of the application, the instruction generator 14 generates a prompt for instructing creation of the application at step S2010, and transmits the prompt to the generative AI system 50 at step S2011. In other words, the user terminal 10A executes a program (an example of a first program) for generating a prompt to be transmitted to the generative AI system 50 and a program (an example of a second program) for transmitting the generated prompt to the generative AI system 50.

The prompt generated at step S2010 is similar to the prompt 90 illustrated in FIG. 11.

In response to reception of the prompt from the user terminal 10A, the generative AI system 50 transmits a response message to the prompt to the user terminal 10A at step S2012. The response message transmitted from the generative AI system 50 to the user terminal 10A is an example of a first request. In the first request, the generative AI system 50 requests the information processing apparatus 20 to create the application based on the application type, the management items of the application, and the setting data.

When the communication unit 11 receives the response message, at S2013, the user terminal 10A transmits an application creation request to the information processing system 20.

In other words, the user terminal 10A executes a program (an example of a third program) that transmits an application creation request to the information processing system 20 in response to a response message from the generative AI system 50.

The request transmitted from the user terminal 10A to the information processing system 20 is an example of a second request, which is a request including the parameters in the response message received by the user terminal 10A at step S2012.

In the user terminal 10A, when the response message is received from the generative AI system 50, the web browser 5A executes the JavaScript®embedded in the screen information to cause the application creation request be transmitted to the information processing system 20.

Since the processes from step S2014 to step S2023 of FIG. 20 are substantially the same as the processes from step S814 to step S823 of FIG. 8, description thereof is omitted.

As described above, according to the present embodiment, the user terminal 10A generates a prompt to be transmitted to the generative AI system 50, thus reducing the processing load on the information processing system 20.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

The apparatuses or devices described in each embodiment are merely one example of plural computing environments that implement one or more embodiments disclosed herein.

In some embodiments, the information processing system 20 includes multiple computing devices, such as a server cluster. The multiple computing devices are configured to communicate with one another through any type of communication link, including a network, a shared memory, etc., to collectively perform the processes disclosed herein.

Further, the multiple computing devices in the information processing system 200 may be configured to share the processing steps disclosed herein in various combinations. For example, a process executed by a predetermined unit may be executed by any number of device included in the information processing system 20. Similarly, the functions executed by one or more functional units may be performed by any one of the computing devices in the information processing system 200. The functional elements of the computing devices in the information processing system 200 may be integrated into one server apparatus or may be divided into a plurality of server apparatuses.

The information processing system 200 may include any number of apparatus having a communication function. Other examples of the information processing system 20 include, but not limited to, an output device such as a Projector (PJ), an Interactive White Board (a white board having an electronic whiteboard function capable of mutual communication (IWB)), and a digital signage, a Head Up Display (HUD) device, an industrial machine, an imaging device, a sound collecting device, a medical device, a network home appliance, an automobile (connected car), a notebook Personal Computer (PC), a mobile phone, a smartphone, a tablet terminal, a game console, a Personal Digital Assistant (PDA), a digital camera, a wearable PC or a desktop PC.

### Aspects

### Aspect 1

An information processing apparatus communicably connected with a terminal apparatus and a generative artificial intelligence (AI) system via a network, includes: a display controller configured to cause the terminal apparatus to display a screen for assisting creation of an application; a controller configured to transmit an instruction to generate parameters for creating the application based on input content input via the screen to the generative AI system; a reception unit configured to receive a request generated by the generative AI system based on the transmitted instruction, the request including the parameters for creating the application; and an application creator configured to create the application based on the parameters included in the received request. The display controller is configured to: display, on the screen, a first option for receiving a selection of an application type of the application to be created from among a plurality of options of the application type; and in response to reception of the selection of the application type from the first option, display on the screen a second option for receiving a selection of one or more items from among candidates of an item to be managed by the application having the selected application type. The controller is configured to transmit, to the generative AI system, the instruction including first information identifying the application type selected from the first option, second information identifying the one or more items selected from the second option, and setting data for creating the application. The reception unit is configured to receive the request generated by the generative AI system based on the first information, the second information, and the setting data.

### Aspect 2

In the information processing apparatus of Aspect 1, the application creator is implemented with execution of a function that is preset. The controller is configured to transmit a function name identifying the function to the generative AI system at least once. The reception unit is configured to receive the request generated by the generative AI system, the request including the function name. The application creator is implemented with execution of the function identified with the function name included in the request that is received.

### Aspect 3

In the information processing apparatus of Aspect 1 or Aspect 2, in a case that the application creator successfully creates the application, the controller causes the display controller to display access information for accessing the application on the screen.

### Aspect 4

In the information processing apparatus of any one of Aspect 1 to Aspect 3, in a case the application creator fails to create the application, the controller causes the display controller to display on the screen an error message indicating that creation of the application fails.

### Aspect 5

In the information processing apparatus of any one of Aspect 1 to Aspect 4, the first option is displayed as a list of the display names of the application types and the operation components that are associated with each other. The first information is a display name of an application type, which is associated with an operation component selected from the first option. The second option is displayed as a list of the item names and the operation components that are associated with each other. The second information is an item name of an item, which is associated with an operation component selected from the second option.

### Aspect 6

In the information processing apparatus of any one of Aspect 1 to Aspect 4, the first option is displayed as a list of operation components each represented by the display name of the application type. The first information is a display name of an application type, which represents an operation component selected from the first option. The second option is displayed as a list of operation components each represented by the item name of the item. The second information is an item name of an item, which represents an operation component selected from the second option.

### Aspect 7

An application creation system includes a terminal apparatus, a generative artificial intelligence (AI) system, and an information processing apparatus that communicate with each other via a network. The information processing apparatus includes: a display controller configured to cause the terminal apparatus to display a screen for assisting creation of an application; a controller configured to transmit an instruction to generate parameters for creating the application based on input content input via the screen to the generative AI system; a reception unit configured to receive a request generated by the generative AI system based on the transmitted instruction, the request including the parameters for creating the application; and an application creator configured to create the application based on the parameters included in the received request. The display controller is further configured to: display, on the screen, a first option for receiving a selection of an application type of the application to be created from among a plurality of options of the application type; and in response to reception of the selection of the application type from the first option, display on the screen a second option for receiving a selection of one or more items from among candidates of an item to be managed by the application having the selected application type. The controller is configured to transmit, to the generative AI system, the instruction including first information identifying the application type selected from the first option, second information identifying the one or more items selected from the second option, and setting data for creating the application. The reception unit is configured to receive the request generated by the generative AI system based on the first information, the second information, and the setting data.

### Aspect 8

A program that causes an information processing apparatus communicably connected with a terminal apparatus and a generative artificial intelligence (AI) system via a network, to perform an application creation method including: displaying, on a display, a screen for assisting creation of an application, the screen including a first option including a plurality of options of an application type of the application to be created; in response to reception of a selected application type selected from the first option, display on the screen a second option including a plurality of options of an item to be managed by the application having the selected application type; in response to reception of one or more selected items selected from the second option, generating an instruction including first information identifying the selected application type, second information identifying the one or more selected items, and setting data for creating the application; transmitting the instruction to the generative AI system; receiving a request generated by the generative AI system based on the transmitted instruction, the request including the setting data for creating the application; and creating the application based on the setting data included in the received request.

### Aspect 9

An application creation method performed by an information processing apparatus communicably connected with a terminal apparatus and a generative artificial intelligence (AI) system via a network, includes: displaying, on a display, a screen for assisting creation of an application, the screen including a first option including a plurality of options of an application type of the application to be created; in response to reception of a selected application type selected from the first option, display on the screen a second option including a plurality of options of an item to be managed by the application having the selected application type; in response to reception of one or more selected items selected from the second option, generating an instruction including first information identifying the selected application type, second information identifying the one or more selected items, and setting data for creating the application; transmitting the instruction to the generative AI system; receiving a request generated by the generative AI system based on the transmitted instruction, the request including the setting data for creating the application; and creating the application based on the setting data included in the received request.

### Aspect 10

A system including an information processing apparatus and a terminal apparatus that are communicably connected via a network. The terminal apparatus includes a display controller configured to display, on a display, a screen for assisting creation of an application; an instruction generator configured to generate an instruction to generate parameters for creating the application based on input content input via the screen for transmission to the generative AI system; a first communication unit configured to communicate with the generative AI system; and a second communication unit configured to communicate with the information processing apparatus. The display controller is configured to: display, on the screen, a first option for receiving a selection of an application type of the application to be created from among a plurality of options of the application type; and in response to receiving the selection of the application type from the first option, display on the screen a second option for receiving a selection of one or more items from among candidates of an item to be managed by the application having the selected type. The instruction generator is configured to generate the instruction including first information identifying the application type selected from the first option, second information identifying the one or more items selected from the second option, and setting data for creating the application. The first communication unit is configured to transmit the generated instruction to the generative AI system, and receive a first request generated by the generative AI system based on the first information, the second information, and the setting data, the first request including the parameters for creating the application. The second communication unit is configured to transmit a second request including the parameters included in the received first request to the information processing apparatus. The information processing apparatus includes: a third communication unit configured to communicate with the terminal apparatus, and receive the second request transmitted from the terminal apparatus; and an application creator configured to create the application based on the parameters included in the received second request.

### Aspect 11

In the application creation system of Aspect 10, the second communication unit receives, from the information processing apparatus, a program for executing generation of the instruction, transmission of the generated instruction to the generative AI system, and transmission of the second request to the information processing apparatus. With execution of the program, the instruction generator generates the instruction, the first communication unit transmits the instruction to the generative AI system, and the second communication unit transmits the second request to the information processing apparatus.

### Aspect 12

In the application creation system of Aspect 10 or Aspect 11, the program includes a plurality of programs including a first program that generates the instruction; a second program that transmits the generated instruction to the generative AI system; and a third program that transmits the second request to the information processing apparatus;

### Aspect 13

In the application creation system of any one of Aspect 10 to Aspect 12, the second communication unit receives data of the screen, which includes the program, from the information processing apparatus. The display control unit causes the display to display the screen based on received data of the screen.

### Aspect 14

In the application creation system of any one of Aspect 10 to Aspect 13, the data of the screen is described in HTML, and the program is described in JavaScript.

### Aspect 15

An application creation method performed by a terminal apparatus communicably connected with an information processing system and a generative artificial intelligence (AI) system via a network. The application creation method includes: displaying, on a display, a screen for assisting creation of an application, the screen including a first option including a plurality of options of an application type of the application to be created; in response to reception of a selected application type selected from the first option, display on the screen a second option including a plurality of options of an item to be managed by the application having the selected application type; in response to reception of one or more selected items selected from the second option, generating an instruction including first information identifying the selected application type, second information identifying the one or more selected items, and setting data for creating the application; transmitting the instruction to the generative AI system; receiving a first request generated by the generative AI system based on the transmitted instruction, the first request including the setting data for creating the application; and transmitting a second request including the setting data included in the received first request to the information processing apparatus, the second request causing the information processing apparatus to create the application based on the setting data included in the received request.

1. An information processing system communicably connected with a terminal apparatus and a generative artificial intelligence (AI) system via a network, the information processing system comprising circuitry configured to:
display, on a display, a screen for assisting creation of an application, the screen including a first option including a plurality of options of an application type of the application to be created;
in response to reception of a selected application type selected from the first option, display on the screen a second option including a plurality of options of an item to be managed by the application having the selected application type;
in response to reception of one or more selected items selected from the second option, generate an instruction including first information identifying the selected application type, second information identifying the one or more selected items, and setting data for creating the application;
transmit the instruction to the generative AI system;
receive a request generated by the generative AI system based on the instruction, the request including the setting data for creating the application; and
create the application based on the setting data included in the request.

2. The information processing system according to claim 1, wherein
the setting data includes a function name identifying a function that causes the creation of the application, and
the circuitry is configured to execute the function identified with the function name included in the request to create the application.

3. The information processing system according to claim 1, wherein, in a case that the creation of the application is successful, the circuitry is configured to display, on the screen, access information for accessing the application.

4. The information processing system according to claim 1, wherein, in a case that the creation of the application fails, the circuitry is configured to display, on the screen, an error message indicating that creation of the application fails.

5. The information processing system according to claim 1, wherein
the screen displays, as the first option, a plurality of display names each identifying the application type and a plurality of first operation components that are associated with each other,
the first information being one of the plurality of display names associated with a first operation component selected from the plurality of first operation components of the first option,
the screen displays, as the second option, a plurality of item names each identifying the item and a plurality of second operation components that are associated with each other, and
the second information being one of the plurality of item names associated with a second operation component selected from the plurality of second operation components of the second option.

6. The information processing system according to claim 1, wherein
the screen displays, as the first option, a plurality of first operation components each represented by a display name of an application type,
the first information being a display name representing a first operation component selected from the plurality of first operation components of the first option,
the screen displays, as the second option, a plurality of second operation components each represented by an item name of an item, and
the second information being an item name representing a second operation component selected from the plurality of second operation components of the second option.

7. An application creation system comprising:
the information processing system according to claim 1; and
the terminal apparatus including the display to display the screen.

8. A terminal apparatus communicably connected with an information processing system and a generative artificial intelligence (AI) system via a network, the terminal apparatus comprising circuitry configured to:
display, on a display, a screen for assisting creation of an application, the screen including a first option including a plurality of options of an application type of the application to be created;
in response to reception of a selected application type selected from the first option, display on the screen a second option including a plurality of options of an item to be managed by the application having the selected application type;
in response to reception of one or more selected items selected from the second option, generate an instruction including first information identifying the selected application type, second information identifying the one or more selected items, and setting data for creating the application;
transmit the instruction to the generative AI system;
receive a first request generated by the generative AI system based on the instruction, the first request including the setting data for creating the application;
transmit a second request including the setting data included in the first request to the information processing system, the second request causing the information processing system to create the application based on the setting data included in the second request.

9. The terminal apparatus according to claim 8, wherein the circuitry is configured to
receive, from the information processing system, a program for executing generation of the instruction, transmission of the instruction to the generative AI system, and transmission of the second request to the information processing system, and
execute the program to generate the instruction, transmit the instruction to the generative AI system, and transmit the second request to the information processing system.

10. The terminal apparatus according to claim 9, wherein the program includes:
a first program that generates the instruction;
a second program that transmits the instruction to the generative AI system; and
a third program that transmits the second request to the information processing system.

11. The terminal apparatus according to claim 9, wherein the circuitry is configured to
receive, from the information processing system, screen data including the program, and
display, on the display, the screen based on the screen data.

12. The terminal apparatus according to claim 11, wherein
the screen data is described in HyperText Markup Language, and the program is described in JavaScript®.

13. An application creation system comprising:
the terminal apparatus according to claim 8; and
the information processing system including another circuitry configured to create the application in response to the second request received from the terminal apparatus.

14. An application creation method comprising:
displaying, on a display, a screen for assisting creation of an application, the screen including a first option including a plurality of options of an application type of the application to be created;
in response to reception of a selected application type selected from the first option, displaying on the screen a second option including a plurality of options of an item to be managed by the application having the selected application type;
in response to reception of one or more selected items selected from the second option, generating an instruction including first information identifying the selected application type, second information identifying the one or more selected items, and setting data for creating the application;
transmitting the instruction to a generative artificial intelligence (AI) system; and
receiving a request generated by the generative AI system based on the instruction, the request including the setting data for creating the application, the setting data including a function name identifying a function that causes creation of the application.
